(19) United States
(12) Patent Application Publication
(10) Pub. No.: US 2013/0055028 A1
(43) Pub. Date: Feb. 28, 2013

(54) METHODS AND SYSTEMS FOR CREATING SOFTWARE TESTS AS EXECUTABLE RESOURCES

(71) Applicants: Rajeshwar Vishwanath Patil, Fremont, CA (US); Ramesh Babu Mandava, Santa Clara, CA (US); Sayantan Satpati, Fremont, CA (US); Lu Chen, San Jose, CA (US); Lax Sharma, San Jose, CA (US); Ramesh Dara, Fremont, CA (US)

(72) Inventors: Rajeshwar Vishwanath Patil, Fremont, CA (US); Ramesh Babu Mandava, Santa Clara, CA (US); Sayantan Satpati, Fremont, CA (US); Lu Chen, San Jose, CA (US); Lax Sharma, San Jose, CA (US); Ramesh Dara, Fremont, CA (US)

(73) Assignee: eBay Inc., San Jose, CA (US)

(21) Appl. No.: 13/599,864

(22) Filed: Aug. 30, 2012

Related U.S. Application Data
(60) Provisional application No. 61/529,515, filed on Aug. 31, 2011.

(51) Int. Cl. G06F 11/36

(52) U.S. Cl. 714/38.1; 714/E11.208

(57) ABSTRACT

Described herein is a new approach for testing in which tests are instrumented and exposed as addressable resources using a REST-ful approach. With this new approach, instrumentation, provisioning and execution of tests are de-coupled, which is not the case with current, traditional testing approaches.

### CROSS-REFERENCE TO RELATED APPLICATION

This application claims the benefit of U.S. Provisional Application No. 61/529,515, filed Aug. 31, 2011, which is incorporated herein by reference in its entirety.

### TECHNICAL FIELD

The present disclosure generally relates to data processing techniques. More specifically, the present disclosure relates to methods, systems and computer program products for testing software with software tests that are created as executable resources using a REST-ful (Representation State Transfer) style of software architecture.

### BACKGROUND

The present state of software testing is complicated. A wide variety of software testing tools exist for performing a wide variety of different types of software tests. However, the tools typically require that the software tests be customized for use with a specific system (e.g., web site/server) and for a particular purpose (e.g., load testing, performance testing, stress testing, security testing, etc.). This limits the reusability of the software tests, and generally requires that any person performing a test have a high level of skill and knowledge to implement, perform and understand the various tests.

### DESCRIPTION OF THE DRAWINGS

Some embodiments are illustrated by way of example and not limitation in the figures of the accompanying drawings, in which:

FIG. 1 is a network diagram illustrating a network environment in which a test portal might be employed, consistent with embodiments of the invention;

FIG. 2 is a block diagram of a system architecture for a testing system or portal, consistent with some embodiments of the invention;

FIG. 3 is a block diagram illustrating different instances of two separate use cases, for a system under test, consistent with some embodiments of the invention;

FIG. 4 is a block diagram of a machine in the form of a computing device within which a set of instructions, for causing the machine to perform any one or more of the methodologies discussed herein, may be executed.

### DETAILED DESCRIPTION

The present disclosure describes techniques for testing software, particularly web-based applications and services, using software tests that are remotely executable as addressable resources via a REST-ful or REST-like interface. In the following description, for purposes of explanation, numerous specific details are set forth in order to provide a thorough understanding of the various aspects of different embodiments of the present invention. It will be evident, however, to one skilled in the art, that the present invention may be practiced without all of the specific details.

As described herein, aspects of the inventive subject matter involve software testing techniques that provide a whole new approach for testing in which the tests are instrumented and exposed as addressable resources using an approach that has become known as a REST-ful approach (where REST stands for Representational State Transfer). A REST-ful approach generally relies on a single application protocol (HTTP), universal resource indicators (URI) and standardized data formats, through XML. It employs established HTTP methods such as GET and POST to direct applications (e.g., invoke and control software testing applications). So instead of creating a standard, machine-readable way for software testing applications to discover and use application components on remote systems—for example, the way SOAP (Simple Object Access Protocol) is used for Web services—REST developers use URIs to create a common ground so software testing applications can use HTTP and XML to share data. REST developers use XML documents rather than application-method calls to tell distributed programs how to use each other's data. Accordingly, with this new approach, instrumentation of software testing is de-coupled from the provisioning and execution of software tests. This does not occur with conventional, prior art testing approaches. With conventional software testing techniques, tests are instrumented for the specific tool/framework.

Consistent with some embodiments of the invention, one objective is to create and provide a framework, based on the principles of the REST-ful approach to software architecture, which can help instrumentation and provisioning of software tests. Based on a particular specification (for example, WSDL, or Web Services Description Language, in the case of web services), a software-testing framework will instrument tests as addressable resources (e.g., addressable with URIs). Accordingly, this software-testing framework can be used to instrument, provision and execute software tests remotely, from any computing device with a conventional web browser application or similar web-based functionality.

In addition to the benefits described above, the software-testing framework will make it possible to facilitate the simple implementation, provisioning and execution of a wide variety of tests, including tests for CI (continuous integration) farm, load tests, performance tests and others. As new services and engineering pipelines are created, the existing software-testing framework will easily integrate to support testing of the new services and pipelines. With some embodiments, the software-testing framework will allow a wide variety of use case tests to be quickly and easily composed by “stitching” together lower-level addressable resources and making those resources executable via a single URI or URL. Overall, the software-testing framework proposed herein facilitates and moves quality upstream.

With some embodiments, URLs or URIs can be used for provisioning or configuring tests (e.g., by specifying input data, etc.), as well as for actually invoking or executing a test. Accordingly, any software application, tool, framework or technology that understands ubiquitous URLs can be used to provision and execute a software test. Consistent with embodiments of the invention, a test plan is simply a file with a list of URLs corresponding with tests to be exercised or invoked. Consistent with some embodiments, the software-testing framework enables orchestration as opposed to a work-flow model. For example, the same tests can be used for multiple purposes using different tools (e.g., eCAF for UI testing, JMeter for volume testing, etc.) by referencing the tests in different test plans.

Consistent with embodiments, software tests that are executable by invoking a URL are advantageous in that the tests need only be written once, but can then be executed or invoked from anywhere—for example, in virtually any computing environment, using conventional web-based protocols and applications. Using a URL interface, software tests are remotely accessible, highly scalable and reliable, thereby supporting CI (continuous integration) of systems and applications by enabling the application of quality control during development, as opposed to only after development. Moreover, test instrumentation can be automatic based on a particular specification (e.g., WSDL, SDK).

For example, by simply logging in (e.g. with username and password) to a testing portal, an administrator can invoke a software test to perform various testing operations on a remotely hosted software application or service. As such, there is no need to be present at the location of the server hosting the application or service that is being tested, or, at the location of the server hosting the testing portal. With some embodiments, simply selecting or clicking on a hyperlink can invoke a test. In other instances, conventional user interface elements may be used to obtain a variety of input data for use in provisioning a test. For example with some embodiments, provisioning of tests can also be supported through addressable provisioning resources.

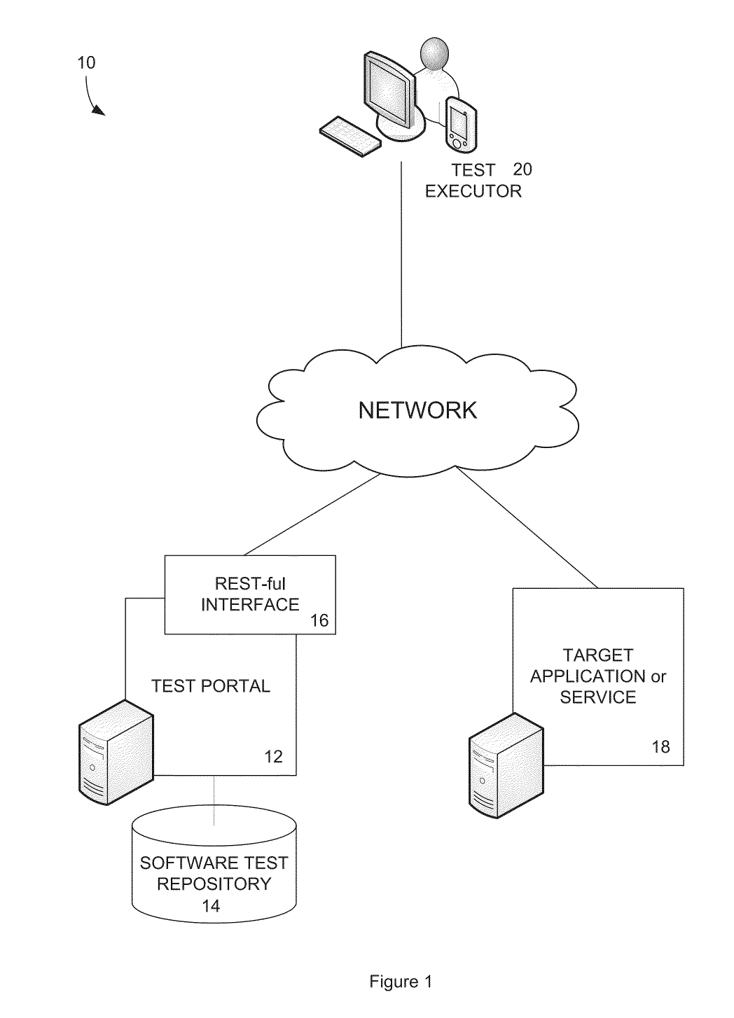

FIG. 1 illustrates a network environment 10 in which a test portal 12 might be employed, consistent with embodiments of the invention. As illustrated in FIG. 10, the test portal may be comprised of one or more server computers. The test portal includes a repository 14 of software testing applications (e.g., tests), with each test having a corresponding URL by which the test can be invoked. When invoked, a test will perform a series of testing operations on a target application or service 18, which may be hosted remotely from both the text executor 20 and the target application 18.

### Framework Details

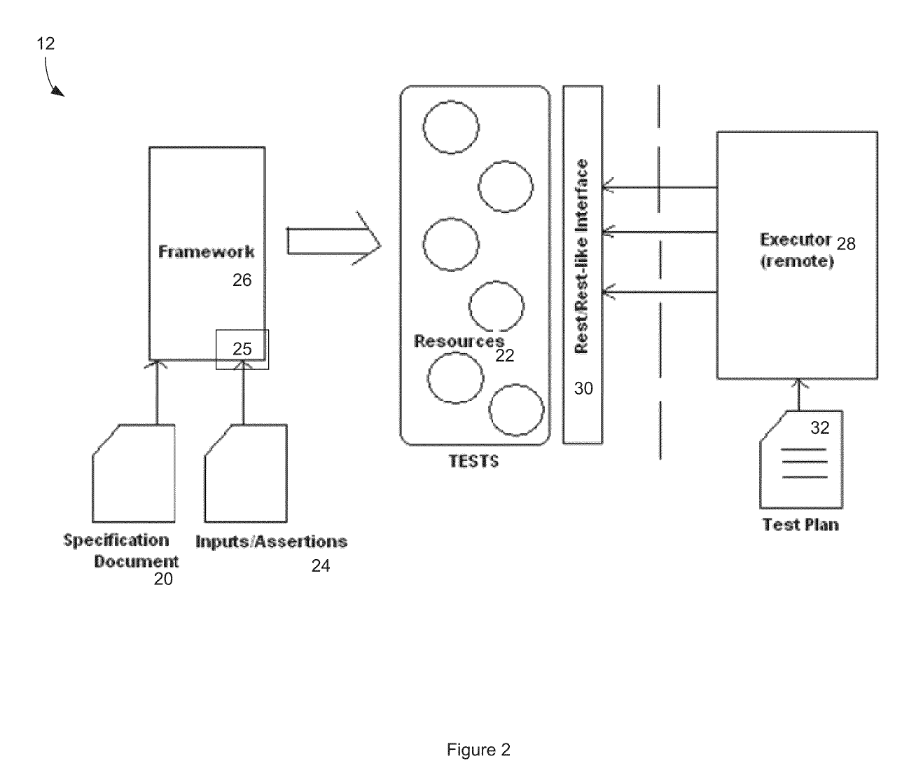

FIG. 2 is a block diagram of a system architecture, including framework 26, for a software-testing system or portal 12, consistent with some embodiments of the invention. Consistent with some embodiments of the invention, using input specifications (for example, Web Services Description Language (WSDL) in the case of services) 20, a software-testing framework will automatically instrument test resources 22 with standard assertions. It will also provide a service provider interface (SPI) 25, to plug-in assertions and/or test resource implementations 24 that are complex or need semantics beyond specification (i.e., protocol semantics). As indicated in FIG. 2, a test executor 28 can remotely invoke a test (e.g., a resource) via a REST-ful or REST-like interface 30. With some embodiments, a test plan 32 has multiple URLs that correspond with multiple tests or resources 22, such that a series of tests can be performed when the executor simply invokes the URLs included in the test plan.

### Resources

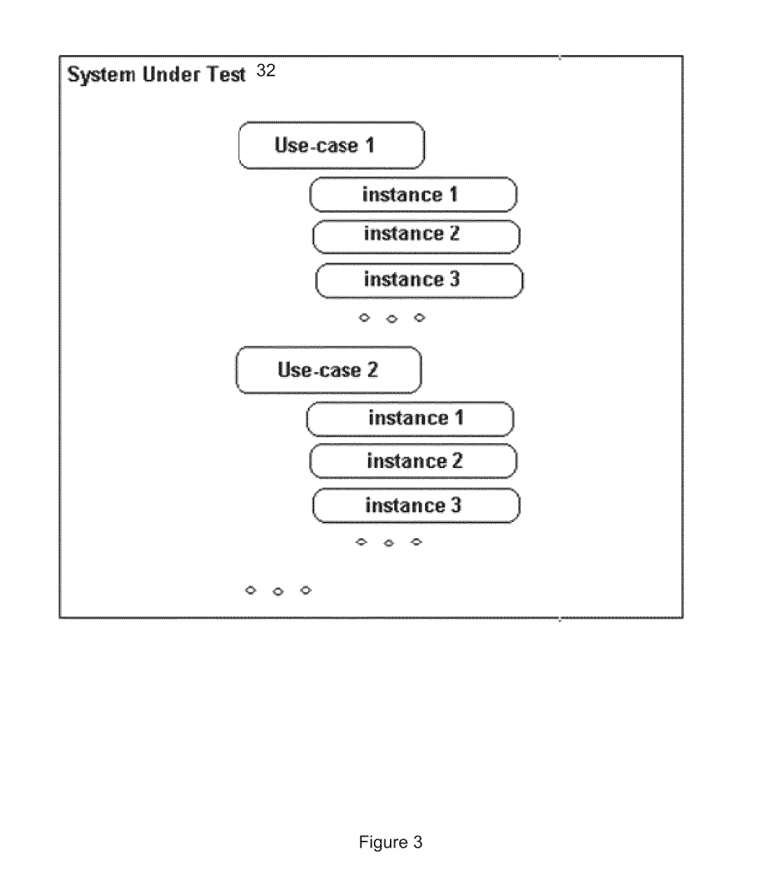

Consistent with some embodiments, the software-testing framework 26 generates three different types of test resources. These resources include a component/service resource, a use-case resource and a use-case instance resource. The component/service resource is used to invoke or exercise all of the individual instances of all the use-cases. In this context, an instance is a variation based on different input and/or constraints, and the term “use-case” is synonymous to the exposed public Application Programming Interface (API). The second test resource is a use-case resource. A use-case resource invokes or exercises all instances of a particular use-case. Finally, the third resource is a use-case instance resource, which invokes or exercises a particular instance (e.g., variation) of a use-case. Accordingly, the three different types of test resources enable selective execution of tests. For example, a user can execute or run all instances of all use-cases of a component/service under test, or instances of a particular use-case or a particular use-case instance. In the example of FIG. 3, a system under test 32 is shown. In this example, the system is being tested with all use-case instances of two different use-case resources—use-case 1, and use-case 2.

### Output Formats

With some embodiments, the framework provides support for different output formats for the individual resources, to include: XML, JSON and/or HTML.

### Input Formats

With some embodiments, the framework provides support for different input formats for the individual resources, to include: query parameters, XML, and/or a spreadsheet (e.g., Excel or others).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules or objects that operate to perform one or more operations or functions. The modules and objects referred to herein may, in some example embodiments, comprise processor-implemented modules and/or objects.

Similarly, the methods described herein may be at least partially processor-implemented. For example, at least some of the operations of a method may be performed by one or more processors or processor-implemented modules. The performance of certain operations may be distributed among the one or more processors, not only residing within a single machine or computer, but deployed across a number of machines or computers. In some example embodiments, the processor or processors may be located in a single location (e.g., within a home environment, an office environment or at a server farm), while in other embodiments the processors may be distributed across a number of locations.

The one or more processors may also operate to support performance of the relevant operations in a “cloud computing” environment or within the context of “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

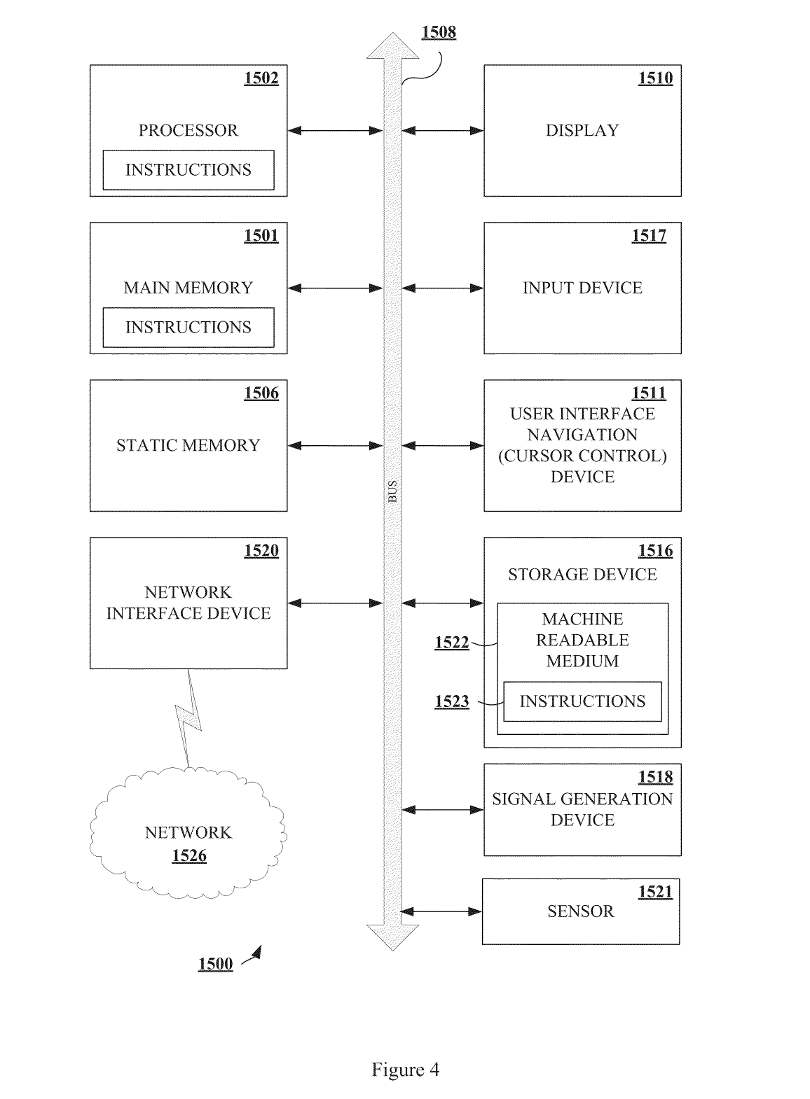

FIG. 4 is a block diagram of a machine in the form of a computer system within which a set of instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in a client-server network environment, or as a peer machine in peer-to-peer (or distributed) network environment. In a preferred embodiment, the machine will be a server computer, however, in alternative embodiments, the machine may be a personal computer (PC), a tablet PC, a set-top box (STB), a Personal Digital Assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1500 includes a processor 1502 (e.g., a central processing unit (CPU), a graphics processing unit (GPU) or both), a main memory 1501 and a static memory 1506, which communicate with each other via a bus 1508. The computer system 1500 may further include a display unit 1510, an alphanumeric input device 1517 (e.g., a keyboard), and a user interface (UI) navigation device 1511 (e.g., a mouse). In one embodiment, the display, input device and cursor control device are a touch screen display. The computer system 1500 may additionally include a storage device 1516 (e.g., drive unit), a signal generation device 1518 (e.g., a speaker), a network interface device 1520, and one or more sensors 1521, such as a global positioning system sensor, compass, accelerometer, or other sensor.

The drive unit 1516 includes a machine-readable medium 1522 on which is stored one or more sets of instructions and data structures (e.g., software 1523) embodying or utilized by any one or more of the methodologies or functions described herein. The software 1523 may also reside, completely or at least partially, within the main memory 1501 and/or within the processor 1502 during execution thereof by the computer system 1500, the main memory 1501 and the processor 1502 also constituting machine-readable media.

While the machine-readable medium 1522 is illustrated in an example embodiment to be a single medium, the term “machine-readable medium” may include a single medium or multiple media (e.g., a centralized or distributed database, and/or associated caches and servers) that store the one or more instructions. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., EPROM, EEPROM, and flash memory devices; magnetic disks such as internal hard disks and removable disks; magneto-optical disks; and CD-ROM and DVD-ROM disks.

The software 1523 may further be transmitted or received over a communications network 1526 using a transmission medium via the network interface device 1520 utilizing any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., Wi-Fi® and WiMax® networks). The term “transmission medium” shall be taken to include any intangible medium that is capable of storing, encoding or carrying instructions for execution by the machine, and includes digital or analog communications signals or other intangible medium to facilitate communication of such software.

Although an embodiment has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

What is claimed is:

1. A computer-implemented method comprising:
at a server computer hosting a software-testing portal having a repository of software tests, with each software test addressable via a URL, receiving an HTTP request via a REST-ful or REST-like interface specifying a URL corresponding with a software test;
responsive to receiving the HTTP request, invoking the software test to perform a test of a software application or service.

2. The computer-implemented method of claim 1, wherein the URL corresponding with the software test is one of several URLs in a single document that comprises a test plan.

3. The computer-implemented method of claim 1, wherein the HTTP request is received over a network via a client-computing device that is remotely located from the server computer hosting the software-testing portal.

4. The computer-implemented method of claim 3, wherein the software application or service on which the test is to be performed is hosted on a server computer remote from the server computer hosting the software-testing portal.

5. The computer-implemented method of claim 1, wherein the software-testing portal enables instrumentation of a software test to be de-coupled from provisioning and execution of the software test by using one or more XML documents to share data.

6. The computer-implemented method of claim 1, wherein the HTTP request is one of a GET or PUT command.

7. The computer-implemented method of claim 1, wherein the software-testing portal provides support for different output formats, including any one or more of: XML, JSON, and HTML.

8. The computer-implemented method of claim 1, wherein the software-testing portal provides support for different input formats for individual software tests, to include: query parameters, XML, and/or a spreadsheet.

9. The computer-implemented method of claim 1, wherein the software testing portal includes a service provider interface to plug-in assertions and/or test resource implementations that require semantics beyond those set forth in a specification.

10. A computer-readable storage medium having instructions stored thereon, which, when executed by a server computer, cause the server computer to perform a method, comprising:
receive an HTTP request via a REST-ful or REST-like interface specifying a URL corresponding with a software test;
responsive to receiving the HTTP request, invoking the software test to perform a test of a software application or service.

11. The computer-readable storage medium of claim 10, wherein the URL corresponding with the software test is one of several URLs in a single document that comprises a test plan.

12. The computer-readable storage medium of claim 10, wherein the HTTP request is received over a network via a client-computing device that is remotely located from the server computer hosting the software-testing portal.

13. The computer-readable storage medium of claim 12, wherein the software application or service on which the test is to be performed is hosted on a server computer remote from the server computer hosting the software-testing portal.

14. The computer-readable storage medium of claim 10, wherein the software-testing portal enables instrumentation of a software test to be de-coupled from provisioning and execution of the software test by using one or more XML documents to share data.

15. The computer-readable storage medium of claim 10, wherein the HTTP request is one of a GET or PUT command.

16. The computer-readable storage medium of claim 10, wherein the software-testing portal provides support for different output formats, including any one or more of: XML, JSON, and HTML.

17. The computer-readable storage medium of claim 10, wherein the software-testing portal provides support for different input formats for individual software tests, to include: query parameters, XML, and/or a spreadsheet.

18. The computer-readable storage medium of claim 10, wherein the software testing portal includes a service provider interface to plug-in assertions and/or test resource implementations that require semantics beyond those set forth in a specification.
